(19) United States
(12) Patent Application Publication
(10) Pub. No.: US 2024/0004605 A1
(43) Pub. Date: Jan. 4, 2024

(54) WEARABLE WITH EYE TRACKING

(71) Applicant: Bose Corporation, Framingham, MA (US)

(72) Inventors: Kathleen S. Krisch, Sudbury, MA (US); George Nichols, Dover, MA (US)

(73) Assignee: Bose Corporation, Framingham, MA (US)

(21) Appl. No.: 18/037,370

(22) PCT Filed: Nov. 17, 2021
(86) PCT No.: PCT/US2021/059635

§ 371 Date: May 17, 2023

Related U.S. Application Data
(60) Provisional application No. 63/114,935, filed on Nov. 17, 2020.

(51) Int. Cl. G06F 3/16; H04R 3/00; G06F 3/01; G02B 27/00; G02B 27/01

(52) U.S. Cl. CPC G06F 3/165; G06F 3/167; H04R 3/005; G06F 3/013; G02B 27/0093; G02B 27/017; G02B 2027/0178

(57) ABSTRACT

Systems and methods are provided that detect at least one of a look direction or a focal depth of a user and execute control actions based upon the detected look direction and/or focal depth.

### BACKGROUND

Audio Frames are wearable personal audio devices, such as sunglasses or eyeglasses having integrated loudspeakers to let users hear audio content like streaming music or virtual personal assistant (VPA) notifications. Audio Frames may also have integrated microphones to detect the user's voice to allow interaction with a VPA or for phone calls, for instance, or to sense the sound in the environment around the user, for hearing assistance or amplification, or to determine environmental context.

It can be a challenge to provide the user with seamless transitions between audio states, for example to pause music when someone starts to speak with you in person; to answer/hang up a phone call; or to change the volume of the audio.

In a specific example for hearing assistance, an additional problem comes lip in implementing directional microphone arrays so that the sounds being emphasized are the ones of most interest to the user. The simplest approach is to optimize directional microphones to aim at what is directly in front of the user, but this approach requires the user to turn their head toward what they want to hear more clearly.

Accordingly, there is a need for alternate methods of providing audio control input, controlling audio output, and/or microphone pickup in wearable audio devices.

### SUMMARY

Systems and methods disclosed herein are directed to systems, methods, and applications that include equipment worn on or about the head and that may have access to a user's eyes, such as by optical, camera, electrical or other modalities of observing or detecting the user's eyes for determining look direction, eye movement, eye gesture detection, and the like. For example, Audio Frames or other devices may be positioned on the face and provided with inward-facing cameras or optical sensors to detect the location and motion of the wearer's eyes and pupils.

A controller may process image or video signals from the cameras or optical sensors to determine look direction, eye movement, eye gesture detection, etc. In addition, by combining the information from both eyes, the user's focal depth or overall look direction may be determined. Various examples of systems and methods described herein apply such eye-focus information to determine the user's needs or preferences, enabling a new type of user interface. Such systems and methods may be beneficially applied to audio devices, such as phones, entertainment, and hearing assistance devices, to provide audio control. In other examples, such eye-focus, look direction, and/or movement information may be applied to other types of device controls and inputs.

Various benefits include convenience, ease of use, and reduction of friction or frustration interacting and controlling devices, as well as discreetness, subtlety, and social acceptability. Additionally, as compared with alternative eye controls such as eye-blink detection, for example, eye-focus, look direction, and/or movement may be more robust as well as more discreet.

According to at least one aspect, a method of controlling a device is provided that includes detecting an individual look direction of a user's left eye at a first point in time, detecting an individual look direction of the user's right eye at the first point in time, determining at least one of a look direction or a focal depth based upon the individual look directions, and taking an action based upon the at least one determined look direction or focal depth.

Some examples include detecting left and right individual look direction from the user's left and right eye, respectively, at a second point in time, determining at least one of a second look direction or a second focal depth based upon the individual look directions at the second point in time, and determining an eye gesture based upon the first and second points in time. Taking the action based upon the at least one determined look direction or focal depth includes taking the action based upon the determined eye gesture. In certain examples the detected eye gesture may be one of maintaining a certain look direction or focal depth for a period of time or moving the look direction or focal depth in a certain path or sequence.

According to some examples the action taken is a selection of a user control input associated with a coupled electronic device.

Various examples include rendering audio to the user and wherein the action taken is an adjustment of the audio being rendered.

Certain examples include detecting audio, by one or more microphones, from the user's environment and wherein the action taken is an adjustment of a signal processing of the detected audio. The adjustment of a signal processing of the detected audio may be an adjustment of a beamforming combination of a plurality of signals from the one or more microphones, in some examples.

Some examples also include detecting audio by one or more microphones from the user's environment and wherein the action taken is an audio prompt to the user. Certain examples include detecting a hazardous condition in the user's environment, based at least upon the detected audio, and wherein the audio prompt is configured to alert the user to the hazardous condition.

Various examples include rendering audio to the user that indicates what action will be taken based upon the detected look direction and/or focal depth.

Certain examples include rendering audio to the user that indicates a selected look direction or a selected eye gesture the user should perform for an action to be taken. Some examples may spatially render the rendered audio to the user such that the indication is heard by the user as coming from the selected direction or as moving in accord with the selected eye gesture.

According to another aspect, a wearable audio device is provided that includes at least one of one or more microphones or one or more loudspeakers, one or more sensors configured to detect an eye of a user of the wearable audio device, and a controller configured to process signals from the one or more sensors to detect an individual look direction of a user's left eye at a first point in time, detect an individual look direction of the user's right eye at the first point in time, determine at least one of a look direction or a focal depth based upon the individual look directions at the first point in time, and take an action based upon the at least one determined look direction or focal depth.

In various examples the controller is further configured to detect left and right individual look direction from the user's left and right eye, respectively, at a second point in time, determine at least one of a second look direction or a second focal depth based upon the individual look directions at the second point in time, determine an eye gesture from the first and second points in time, and wherein taking an action based upon the at least one determined look direction or focal depth includes taking an action based upon the determined eye gesture. The detected eye gesture may be one of maintaining the look direction or the focal depth for a period of time or changing the look direction or the focal depth according to a certain path or sequence.

In some examples the action taken may be a selection of a user control input associated with a coupled electronic device.

In certain examples the controller is further configured to render audio to the user, by the at least one of the one or more loudspeakers, and wherein the action taken is an adjustment of the audio being rendered.

In various examples the controller is further configured to detect audio, by the at least one of the one or more microphones, from the user's environment and wherein the action taken is an adjustment of a signal processing of the detected audio. The adjustment of a signal processing of the detected audio may be an adjustment of a beamforming combination of a plurality of signals from the one or more microphones.

Some examples include detecting audio by the at least one of the one or more microphones from the user's environment and wherein the action taken is an audio prompt to the user. Certain examples include detecting a hazardous condition in the user's environment, based at least upon the detected audio, and wherein the audio prompt is configured to alert the user to the hazardous condition.

According to various examples, the controller may be further configured to render audio to the user, by the at least one of the one or more loudspeakers, that indicates what action will be taken based upon the detected look direction and/or focal depth.

According to some examples, the controller may be further configured to render audio to the user, by the at least one of the one or more loudspeakers, an indication to look in a selected direction or perform a selected eye gesture for a certain action to be taken. In certain examples the controller may be further configured to spatially render the rendered audio to the user such that the indication is heard by the user as coming from the selected direction or as moving in accord with the selected eye gesture.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is a front perspective view of an example device worn by a user:

FIG. 2 is a rear perspective view of the example device of FIG. 1; and

FIG. 3 is a schematic diagram of various user eye look directions and focal distances.

### DETAILED DESCRIPTION

Aspects of the present disclosure are directed to systems and methods suitable for use in an audio device worn on or about the head of a user. The systems and methods include sensors to detect eye location and derive therefrom information such as look direction, eye movements, eye gestures, and eye-focus. Such information is used to control the audio device or other equipment coupled to the audio device, such as by wired or wireless connections, e.g., a smartphone or other portable audio and/or communications device(s).

According to various examples, look direction and focal depth (e.g., distance) may control microphone functionality, including array algorithm functionality, such as variable beam width, steerable beamforming (where a microphone array's direction is steered by and/or focused by look direction and eye-focus), and the like, and which may be combined with other adaptive beamforming, such as where an algorithm (implemented by the controller) may steer the array based on additional information, such as relative loudness and spectral content of sounds from different directions.

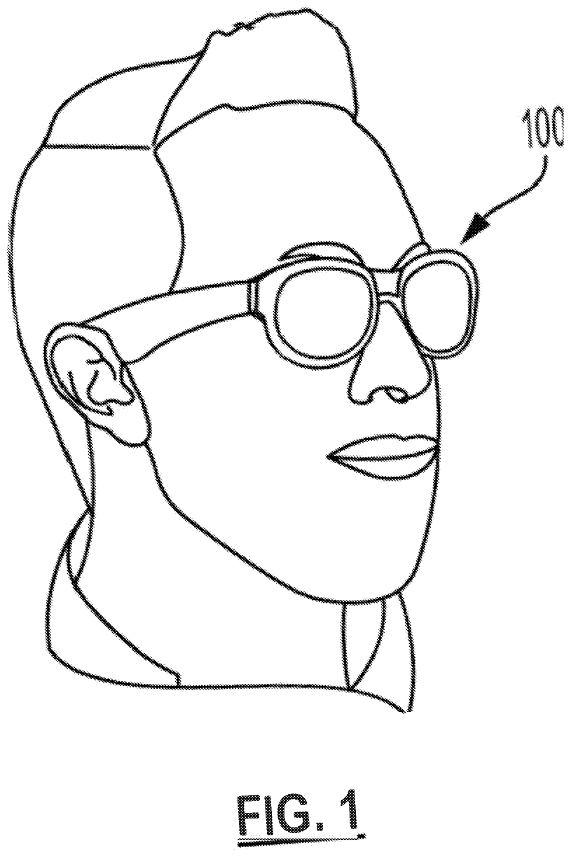

FIG. 1 is a front perspective view of an example wearable audio device 100 illustrated as a pair of wearable lenses, glasses, or frames worn by a user. Other examples tray include a headphone, neck-worn, or other device form factor that may be worn about the head of a user and configured to be positioned such that one or more sensors, e.g., optical sensors 110, may detect the eyes of the user.

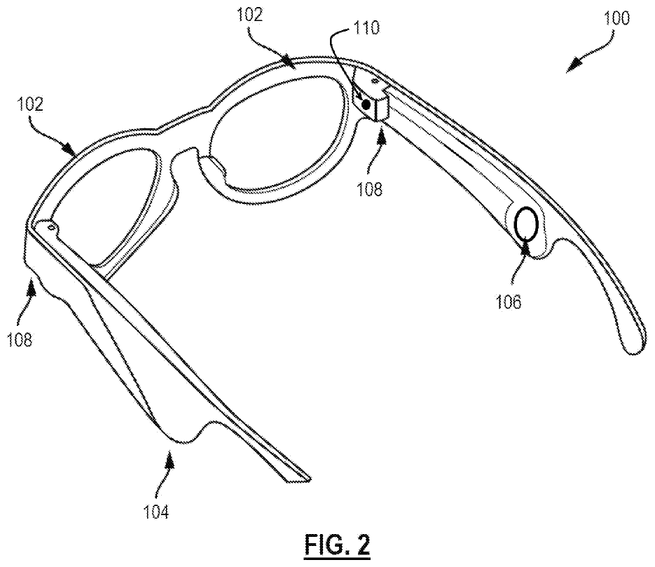

FIG. 2 is a rear perspective view of the audio device 100 in accordance with at least one example embodiment as a pair of glasses. Audio device 100 includes two eye frames 102, which may contain lenses, whether prescription or not and whether tinted or not, connected to each other by a bridge, and each eye frame 102 is coupled to a respective temple arm 104 by any suitable mechanism, such as a hinge. The eye frames, bridge, lenses, and temple arms may be as conventionally known in the art. In various examples, however, one or more of the temple arms 104 may include an acoustic transducer 106 (e.g., a loudspeaker) configured to direct acoustic audio output to the user's ear. In various examples, each side, e.g., left and right, may include one or more acoustic transducers 106. The audio device 100 also may include one or more microphones 108, which may be on an underside of one or more of the temple arms 104, to be directed primarily toward either the user's mouth or the environment in front of the user, or both. Accordingly, the example of FIG. 2 does not explicitly show the microphone(s) 108 as they are obscured by the perspective view.

The audio device 100 may also include one or more sensors 110 positioned in proximity to at least one of the user's eyes. In various examples, the sensor(s) 110 may be an optical device, such as a camera. In some examples the sensor(s) 110 may be active such that they may emit an optical signal, such as an infrared signal or pulse, and include an infrared sensor to detect reflected infrared light form the user's eyes. Such an infrared emitter may be a distinct device and may be separately positioned on the audio device 100. Various examples may include other types of sensors capable of detecting an orientation of one or more of the user's eve(s). While only one sensor 110 is illustrated in FIG. 2, e.g., on the right-hand side, a similar sensor 110 may be provided on the left-hand side in various examples. In some examples, a single sensor may be positioned to detect both of the users eyes, such as a sensor mounted within or upon the bridge of the glasses of audio device 100 and having a field of view wide enough to detect both eyes.

A controller (not explicitly shown) may be integrated to the audio device 100 and coupled to each of the acoustic transducer(s) 106, the one or more microphones 108, and the one or more sensors 110, to receive signals from the microphone(s) 108 and the sensor(s) 110 and to provide signals to the acoustic transducer(s) 106. Such a controller may be implemented by any suitable processing, such as a generic processor or a custom processor, and some function may be carried out by a digital signal processor (DSP) or a math co-processor. The controller may include volatile and/or non-volatile memory, such as random access memory to temporarily store information and executable instructions, and long term memory or storage device to store long term information and executable instructions, such as programs, data, and the like. The audio device 100 and/or the controller may include power storage, such as a battery, to provide power to the controller and the audio device 100. The controller may include other input and output couplings, such as wireless interfaces to interact with and provide signals to other devices or systems, such as portable devices like smart phones, tablets, and other computing devices, etc. Examples of various signals include audio signals, control signals, and the like.

Normal sight in humans involves binocular vision. When looking at an object, the eyes are moved so the scene or object at which the person is looking forms an image in the center of the retina of each eye. Looking at a nearby object may cause the eyes to rotate toward each other (convergence), while looking at a more distant object nay cause the eyes to rotate away from each other (divergence). Accordingly, by detecting the individual look direction of each eye a controller may determine an overall look direction and a focal depth.

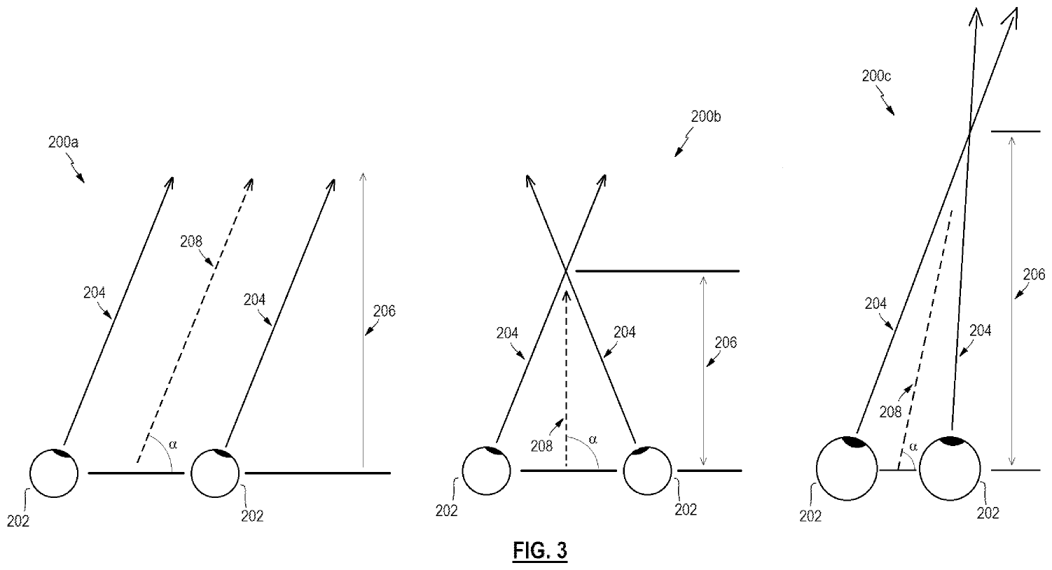

FIG. 3 schematically illustrates various scenarios 200 of the user's eyes 202. In various examples, the one or more sensors 110 may be positioned to observe or sense each of the user's eyes 202, and a controller (not explicitly illustrated) may process signals from the sensors 110 to determine an individual look direction 204 of each eye 202. An intersection point of each individual look direction 204 determines a focal point of the user's gaze, which may be described as a combination of a focal depth 206 and a look direction 208. The focal depth 206 may be the distance to the object (or point) at which the user is looking, and the look direction 208 is the direction to the object (or point) at which the user is looking, which may be characterized in some examples by a look angle, a. Of the three scenarios 200 illustrated in FIG. 3, the scenario 200a occurs when the user is looking to one side at a distant object. The scenario 200b illustrates the user looking at something nearby and straight ahead. The scenario 200c illustrates looking at something a little further off, but still relatively close, and to the side. As illustrated by FIG. 3, from detected individual look directions 204 (of each eye 202), a controller may determine the general or overall look direction 208 and a focal depth 206.

According to various examples, audio devices, systems, and methods may steer a microphone beamformer to the direction a user is looking, rather than the direction the user is facing. Focus direction information may also be used to steer a microphone array beamforming algorithm, so that it has maximum sensitivity in the direction a user is looking even if it is not the direction the user is facing or a direction from which sound is the loudest. People's eyes ray move to focus on sounds of interest with more range, precision and speed than head movement. For example, in a conversation or meeting with multiple people, a listener's eye focus may be directly on who is speaking, while their head direction may change only slightly. Accordingly, various examples steer a beamforming microphone array in a direction to which the user's eyes are focused, e.g., their look direction 208. Therefore, audio devices, systems, and methods in accord with those herein provide an easier, lower-friction experience than existing solutions that may require the user to adjust settings manually or that may make automated selections based upon other means, such as head orientation or the loudest sound rather than the most important sound.

According to some examples, audio devices, systems, and methods may use eye focal depth as an input for context-based functionality. Focal depth can be a valuable piece of contextual information to determine user needs or intent. For example, user intent may be inferred from the state of the audio and from the change in state of the eyes. For example, a person in an office or coffee shop doing heads-down work, might want to listen to music or masking sounds. In this case, their eyes would be focusing on a book or a computer—a shorter focal depth. If someone approaches, the person would look up from their work. In various examples a controller detects the sustained change in the user's focal depth, and may make accordant changes to an audio playback, such as reducing a volume of playback or turning it off entirely. In some examples, other features of the audio device may additionally or alternatively be adjusted, such as changing an amount of noise reduction (e.g., active noise reduction, ANR). Various examples include performing opposing functions when the user returns his head position and focal depth. e.g., back down to a book or laptop, for instance. In some examples, a controller may take into account additional information for determining the proper contextual actions, such as inputs from accelerometers or other motion detectors on an audio device, e.g., the user's focal depth changes in conjunction with a head movement.

According to certain examples, signals from the one or more microphones 108 may be processed by the controller in combination with those from the sensor(s) 110, upon which various environmental conditions or factors may be determined and appropriate actions may be executed by the controller. Further, inputs from additional sensors, such as inertial measurement units (e.g., accelerometers), magnetometers, positioning systems (e.g., global position system, GPS, receivers), etc. may be combined to determine an environmental condition upon which an appropriate action may be selected and executed by the controller.

Accordingly, various examples of an audio device, system, or method in accord with those herein may include sensors to determine look direction and/or focal depth, as discussed above, microphones to determine environmental sounds, and other sensors to determine head position and/or body position, location information, and various sensors that may scan or detect the environment, such as camera or other optical sensors that may provide video signals indicative of the surroundings.

Accordingly, the controller associated with an audio device, system, or method in accord with those herein, through such various sensors, and as described in more detail above, could determine where a user's eyes are focusing, which way the user's head is positioned, and the user's general motion. Additionally, the controller may process audio signals from microphones to monitor the environment and in response provide outputs, such as audio warnings, of possible safety concerns.

For example, the controller may be programmed or otherwise configured to classify detected audio, such as via an audio classification algorithm, machine learning, etc. In some instances, audio classification may detect vehicles, alarms, sirens, etc.

For example, workers in high traffic areas, such as airports, storage depos, etc. may at times perform their jobs with lower awareness of their environment. Such workers are taxed even more now with the increased use of communication and personal devises. Accordingly, by knowing where the worker is looking, and in combination with other data (e.g., sensed audio via microphones, tracking data, etc.) the controller could provide audio warnings of incoming vehicles or other dangerous circumstances.

Individuals walking in the streets and at the same time occupied by their personal devices, could be warned of different situations. And as smart phones continue to become more powerful and content rich, users will be devoting more time and attention to these devices than everyday tasks that we are very familiar with, like walking.

By knowing eye focusing, direction of head, body motion, and the environment, the controller may alert the user, or interrupt the user's attention, to draw attention to items that the user might otherwise ignore and/or might cause harm. The controller could be adapted or programmed to assist users as they get older. As people age, awareness of their environment may decrease. The controller may be programmed or otherwise configured to attract the user's attention or intervene under various circumstances.

Accordingly, various audio devices, systems, and methods in accord with those herein may assist with safety, warning, and awareness solutions.

According to various examples, audio devices, systems, and methods may use eye focal depth or look direction as a discreet user input, to make changes to an operation of the audio device without drawing attention to the user's actions. For example, the user can use discreet eye gestures to indicate an intended change to operation. Conventional examples of eye gesture control include detection of eye-blinking, for example in devices that assist in communication by people with physical impairments. Some examples in accord with those described herein include blink detection to enable user interfaces for audio devices, however, various examples herein use focal depth and/or look direction as a more subtle and potentially more robust way of signaling that a change in operation or other action should be taken. For example, if a person is wearing such an audio device in a meeting, and a phone call comes in, a detection of the user's eyes looking left for a period of time, e.g., 2 seconds, may be configured to take a first action with respect to the incoming phone call, such as to answer the phone call. A detection the that user looks right for a period of time may take an alternate action, such as sending the incoming call to voicemail. The various actions may be user configurable and/or may be associated with a certain app on the associated communication device, e.g., a smartphone.

In various examples, look directions and/or eye gestures may be used for audio control, such as play, pause, skip forward, skip back, volume up, volume down, and the like. In other instances, look direction and/or eye gesture may be used to control active noise reduction (ANR), such as to adjust ANR between various level setting, e.g., transparent, medium, or full ANR. According to some examples and/or applications on a coupled mobile device, look direction and/or eye gesture may be used to control call acceptance, call termination (hang up), transfer to voicemail, etc. Voicemail application options may also be selected via look direction and/or eye gesture, such as save, delete, replay, call-back, etc. According to various examples in accord with those herein, look direction and/or eye gesture may be used to control navigation functions, such as next maneuver, changing views, etc. In other instances, look direction and/or eye gesture may be used to control or interact with various audio prompts, calendar items, favorites, etc. In general, any of various examples in accord with those herein may use look direction and/or eye gesture to control any of a variety of applications associated with the audio device and/or a coupled device.

In certain examples, an audio prompt may indicate to the user what gesture is necessary to trigger what action. For instance, audio prompts may be rendered from the side that the user should look in order to select them.

Other eye movement gestures are contemplated by various examples in accord with those described herein. For example, looking up or looking down, or at angles, or looking in a first direction followed by a second direction. An eyeroll may be in input gesture in some examples, or any other sequence. Specific eye movements may be user configurable across an infinite range of look directions, movements, and/or focal depth. Additionally, control actions to be taken upon detection of such eye gestures may be configurable by the user.

In various examples, the control action to be taken may depend upon and/or may be inherent to existing user control inputs associated with an application executed by the audio device and/or an associated coupled device. Such applications need not be aware of the eye detection controller. For example, an existing application running on a smartphone may provide various user control inputs and an eye detection controller may activate the user control inputs based upon detected look direction, eye movements, eye gestures, focal depth, and the like, without the application having been designed to work with eye detection.

As another example of discreet operation, a person wearing an audio device in accord with those herein may want to subtly activate a virtual personal assistant (VPA), or replay a VPA message, to get an audio prompt without drawing attention from others. The user may change their focus in a specific pattern that indicated message playback, like a quick and deliberate sequence of near-far-near-far focus. This is an example of focal depth eye signaling.

In various examples, directional and focal eye signaling may be combined for various additional user interface options.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method of controlling an audio device, the method comprising:
detecting an individual look direction of a user's left eye at a first point in time;
detecting an individual look direction of the user's right eye at the first point in time;
determining at least one of a look direction or a focal depth based upon the individual look directions; and
taking an action based upon the at least one determined look direction or focal depth.

2. The method of claim 1 further comprising detecting left and right individual look direction from the user's left and right eye, respectively, at a second point in time, determining at least one of a second look direction or a second focal depth based upon the individual look directions at the second point in time, determining an eye gesture based upon the first and second points in time, and wherein taking an action based upon the at least one determined look direction or focal depth includes taking an action based upon the determined eye gesture.

3. The method of claim 2 wherein the detected eye gesture is one of maintaining a certain look direction or focal depth for a period of time or moving the look direction or focal depth in a certain path or sequence.

4. The method of claim 1 wherein the action taken is a selection of a user control input associated with a coupled electronic device.

5. The method of claim 1 further comprising rendering audio to the user and wherein the action taken is an adjustment of the audio being rendered.

6. The method of claim 1 further comprising detecting audio, by one or more microphones, from the user's environment and wherein the action taken is an adjustment of a signal processing of the detected audio.

7. The method of claim 6 wherein the adjustment of a signal processing of the detected audio is an adjustment of a beamforming combination of a plurality of signals from the one or more microphones.

8. The method of claim 1 further comprising detecting audio, by one or more microphones, from the user's environment and wherein the action taken is an audio prompt to the user.

9. The method of claim 8 further comprising detecting a hazardous condition in the user's environment, based at least upon the detected audio, and wherein the audio prompt is configured to alert the user to the hazardous condition.

10. (canceled)

11. The method of claim 1 further comprising rendering audio to the user that indicates a selected look direction or a selected eye gesture the user should perform for an action to be taken.

12. (canceled)

13. A wearable audio device comprising:
at least one of one or more microphones or one or more loudspeakers;
one or more sensors configured to detect an eye of a user of the wearable audio device; and
a controller configured to process signals from the one or more sensors to:
detect an individual look direction of a user's left eye at a first point in time,
detect an individual look direction of the user's right eye at the first point in time,
determine at least one of a look direction or a focal depth based upon the individual look directions at the first point in time, and
take an action based upon the at least one determined look direction or focal depth.

14. The wearable audio device of claim 13 wherein the controller is further configured to detect left and right individual look direction from the user's left and right eye, respectively, at a second point in time, determine at least one of a second look direction or a second focal depth based upon the individual look directions at the second point in time, determine an eye gesture from the first and second points in time, and wherein taking an action based upon the at least one determined look direction or focal depth includes taking an action based upon the determined eye gesture.

15. The wearable audio device of claim 14 wherein the detected eye gesture is one of maintaining the look direction or the focal depth for a period of time or changing the look direction or the focal depth according to a certain path or sequence.

16. The wearable audio device of claim 13 wherein the action taken is a selection of a user control input associated with a coupled electronic device.

17. The wearable audio device of claim 13 wherein the controller is further configured to render audio to the user, by the at least one of the one or more loudspeakers, and wherein the action taken is an adjustment of the audio being rendered.

18. The wearable audio device of claim 13 wherein the controller is further configured to detect audio, by the at least one of the one or more microphones, from the user's environment and wherein the action taken is an adjustment of a signal processing of the detected audio.

19. The wearable audio device of claim 18 wherein the adjustment of a signal processing of the detected audio is an adjustment of a beamforming combination of a plurality of signals from the one or more microphones.

20. The wearable audio device of claim 13 further comprising detecting audio, by the at least one of the one or more microphones, from the user's environment and wherein the action taken is an audio prompt to the user.

21. The wearable audio device of claim 20 further comprising detecting a hazardous condition in the user's environment, based at least upon the detected audio, and wherein the audio prompt is configured to alert the user to the hazardous condition.

22. (canceled)

23. The wearable audio device of claim 13 wherein the controller is further configured to render audio to the user, by the at least one of the one or more loudspeakers, an indication to look in a selected direction or perform a selected eye gesture for a certain action to be taken.

24. (canceled)
